(19) United States
(12) Patent Application Publication
(10) Pub. No.: US 2026/0253500 A1
(43) Pub. Date: Aug. 27, 2026

(54) DETERMINING AND ADAPTING AN OPERATIONAL PLAN FOR AERIAL VEHICLES DURING OPERATIONAL TASKS

(71) Applicant: Honeywell International, Inc., Charlotte, NC (US)

(72) Inventors: Karthikeyan M, Madurai (IN); Gobinathan Baladhandapani, Madurai (IN); Srilakshmi Kurudi, Bangalore (IN); Sivakumar Kanagarajan, Bangalore (IN); Muthusankar Subramaniyan, Brno (CZ)

(21) Appl. No.: 19/189,269

(22) Filed: Apr. 25, 2025

(30) Foreign Application Priority Data
Feb. 26, 2025 (IN) 202511017033

(51) Int. Cl. G08G 5/30; G08G 5/26; G08G 5/76

(52) U.S. Cl. CPC G08G 5/30; G08G 5/26; G08G 5/76

(57) ABSTRACT

Example approaches for determining an operational plan for a plurality of aerial vehicles are disclosed. In an example, operation data including operational objective information, aerial vehicle operational parameters, and weather data is obtained. The operational objective information corresponds to an operational task to be performed by the plurality of aerial vehicles and includes requirements and constraints of the operational task. The aerial vehicle operational parameters indicate operational capabilities of each aerial vehicle. The weather data comprises current and forecasted conditions for an operational area. Based on the operation data, an operational plan specifying instructions for each selected aerial vehicle to achieve the operational objective is determined. Thereafter, portions of the operational plan specific to each selected aerial vehicle are then selectively transmitted. During execution, real-time values of in-flight operational attributes are analyzed against ideal values, and the operational plan may be updated if deviations are detected.

### BACKGROUND

Various aerial vehicles, specifically performing tasks such as aerial surveys, environmental monitoring, or surveillance, involve planning, coordination and communication between the aerial vehicles to ensure safety, efficiency, and reliability. These tasks require real-time decision-making and adaptive strategies to manage multiple aerial vehicles in dynamic environments. The planning process typically incorporates various data points, including but not limited to, task objectives, vehicle capabilities, weather conditions, terrain characteristics, and operational constraints.

### BRIEF DESCRIPTION OF FIGURES

Systems and/or methods, in accordance with examples of the present subject matter are now described and with reference to the accompanying figures, in which:

FIG. 1 illustrates a computing system for determining an operational plan for a plurality of aerial vehicles, as per an example;

FIG. 2 illustrates an operational task management environment comprising an operational task management system for determining an operational plan for a plurality of aerial vehicles, as per an example;

FIG. 3 illustrates a detailed block diagram of an operational task management system, as per an example;

FIG. 4 illustrates a coordinated multi-aerial vehicle operation within an operational area, as per an example;

FIG. 5A-5B illustrates allocation of specific search patterns and/or search paths to various aerial vehicles by an operational task management system, as per an example;

FIG. 6 illustrates a method for determining an operational plan for a plurality of aerial vehicles, as per an example;

FIG. 7A-7C illustrates a method for determining and adapting an operational plan corresponding to a plurality of aerial vehicles, as per an example; and

FIG. 8 illustrates a system environment implementing a non-transitory computer readable medium for adapting an operation plan corresponding to a plurality of aerial vehicles, as per an example.

### DETAILED DESCRIPTION

Operational tasks, requiring involvement of multiple vehicles, encompass a wide range of activities that require organized execution to achieve specific objectives. Such operational tasks may involve coordination of multiple vehicles, precise navigation through varied terrains, real-time data collection and analysis, and adaptive decision-making in dynamic environments. Such operational tasks may include surveys, remote sensing operations, payload delivery, environmental monitoring, emergency response activities, and surveillance and reconnaissance. The effective execution of these tasks often relies on sophisticated planning systems, robust communication networks, and advanced sensor technologies integrated into the vehicles. In each of these tasks, the effectiveness of the response may significantly impact the desired outcome of the operational task and potentially save lives.

To perform such operational tasks, aerial vehicles are generally deployed because of their ability to cover large areas quickly, access remote or difficult terrain, and provide aerial perspectives, making them invaluable assets in these operational tasks. Examples of some aerial vehicles which may be used during such tasks may include, but are not limited to, helicopters, vertical take-off aircraft, normal fixed wing aircrafts, and unmanned aerial vehicles (UAVs) or drones. Generally, such aerial vehicles are equipped with various sensors, communication systems, and specialized equipment to support specific operational task requirements.

At present, conventional approaches for planning, coordination and communication between aerial vehicles for operational tasks typically involve manual processes conducted by human operators. These processes often include assessing operational requirements and objectives, evaluating available resources, analyzing terrain and weather conditions, and creating flight plans. Human operators manually review operational task parameters, consult physical maps or digital mapping systems, and use their experience to plot flight paths. They may also manually calculate fuel requirements, estimate time-on-target, and determine optimal search patterns based on the type of operational task. Communication between aerial vehicles is often managed through radio transmissions, with operators relaying information and coordinating movements. Weather forecasts and terrain data are typically gathered from multiple sources and interpreted by experienced personnel to assess potential risks and adjust plans accordingly.

However, these conventional approaches face numerous technical challenges and limitations. One of such challenges is the difficulty in maintaining reliable real-time communication between multiple aerial vehicles, especially in remote or challenging environments. This may lead to data synchronization problems and potential safety risks. Another technical challenge is the complexity of coordinating multiple vehicles simultaneously while considering various dynamic factors such as changing weather conditions, unexpected obstacles, or evolving operational task parameters. Manual coordination often lacks the computational power to optimize flight paths and resource allocation in real-time, potentially leading to inefficient operations. Further, sensor fusion and data integration from multiple aerial vehicles present another challenge due to which conventional approaches may struggle to effectively combine and analyze data from various sources in real-time, potentially missing critical insights or delaying decision-making processes.

Approaches for determining an operational plan for a plurality of aerial vehicles performing an operational task are described. In an example, the operational plan includes instructions for one or more aerial vehicles which are selected from the plurality of aerial vehicles to achieve an operational objective efficiently. The determination of the operational plan, in an example, may be used to optimize aerial vehicle performance, enhance operational task effectiveness, and improve operational efficiency during various phases or weather conditions which are to be experienced by the aerial vehicles.

In an example, a system implementing the above referenced approaches may obtain operation data comprising operational objective information, aerial vehicle operational parameters, and weather data. The operational objective information corresponds to the operational task which is to be performed by the plurality of aerial vehicles and includes a value of an operational task parameter specifying requirements and constraints of the operational task. Further, the vehicle operational parameters indicate operational capabilities of each of the plurality of aerial vehicles. The weather data comprises current and forecasted weather data of an operational area which is to be covered by the aerial vehicles for execution of the operational task.

Based on the operation data, the system determines an operational plan comprising a value of an operational output parameter for one or more aerial vehicles selected from the plurality of aerial vehicles. In an example, the system analyze the data included within the operation data with respect to a predefined set of rules to determine the operational plan. In on example, the predefined set of rules indicates optimal flight paths, resource allocation, coverage patterns, and coordination strategies based on the operational objective information, aerial vehicle operational parameter, and weather data. Thus, the operational plan specifies instructions for each selected aerial vehicle to achieve the operational objective. The system then causes transmission of only the portion of the operational plan specific to each selected aerial vehicle.

In another example, the determination of operational plan includes, initially, determining a first coverage area corresponding to a first aerial vehicle based on the operation data. In an example, the determination may involve analyzing the operational objective information, vehicle operational parameters, and weather data. The first coverage area is then analyzed to determine whether it covers a threshold coverage area or not. In an example, the threshold coverage area may be defined based on the specific requirements of the operational task, such as the total area that needs to be searched or monitored within a given timeframe. If the first coverage area fails to cover the threshold coverage area, determination of a second coverage area corresponding to a second aerial vehicle is initiated. The second coverage area is then calculated, taking into account the already determined first coverage area to ensure efficient use of resources and avoid unnecessary overlap.

In yet another example, real-time updating of operational plan is described. This example involves determination of a current operational plan based on the operation data. Such current operational plan is formulated by analyzing the operational objective information, vehicle operational parameters, and weather data to create a comprehensive strategy for executing the operational task. Thereafter, during the execution of the operational task in accordance with the determined operational plan, real-time values of in-flight operational attributes are received for each selected aerial vehicle. Examples of such attributes may include current position, altitude, speed, heading, fuel level, battery charge level, sensor status, communication signal strength, detected obstacles, weather conditions encountered, operational task progress indicators, equipment status, or payload status.

Each received real-time value is then analyzed with respect to an ideal value. The ideal value for each attribute is determined based on the time elapsed from the start of the operational task and the expected progress or status at that point in the operational task. The comparative analysis allows for a continuous assessment of how well each aerial vehicle is performing relative to the planned operational plan. For example, if a real-time value of an in-flight operational attribute fails to achieve its corresponding ideal value, it triggers a recalculation process. The process determines updated values for the operational output parameters for each selected aerial vehicle. The operational output parameters may include factors such as entry location, exit location, time of departure, time of arrival, attributes representing coverage area, number of aerial vehicles required, search patterns corresponding to each aerial vehicle, flight paths corresponding to each aerial vehicle, speed corresponding to each aerial vehicle, and altitude of operation of each aerial vehicle.

These approaches provide technical advancements in performance of operational tasks by aerial vehicle by proper management and coordination within the aerial vehicles. By leveraging real-time data processing and adaptive planning techniques, the system provides a dynamic approach for determining and updating operational plans for multiple aerial vehicles. This approach allows for more precise and situation-specific task allocation, potentially expanding the operational capabilities of the aerial vehicles while adapting to changing conditions during operational task execution.

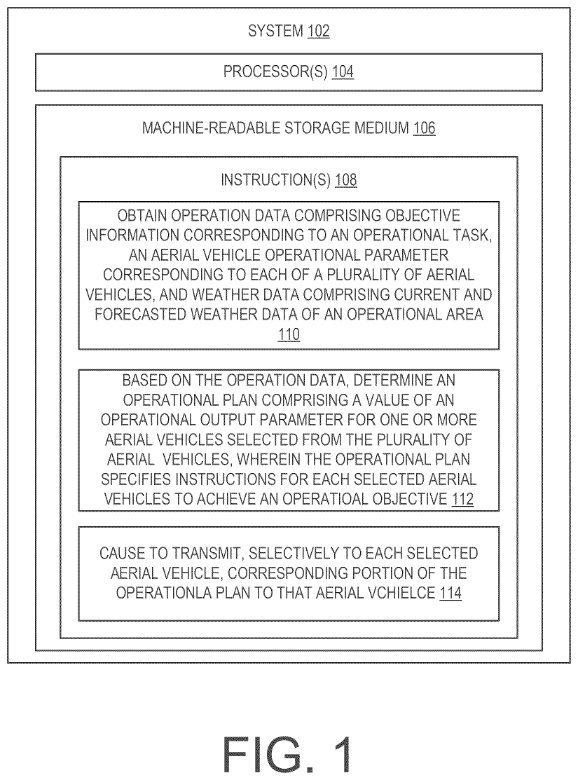

FIG. 1 illustrates an exemplary system 102 for managing aerial vehicle operations. The management of operation of aerial vehicles is done by determining an operational plan based on operation data, which includes operational objective information, aerial vehicle operational parameters, and weather data for an operational area. The system 102 processes the operation data to generate an operational plan that specifies instructions for one or more aerial vehicles which are selected to achieve the operational objective.

The system 102 includes a processor 104, and a machine-readable storage medium 106 which is coupled to, and accessible by, the processor 104. The system 102 may be implemented in any computing system, such as a cloud-based server, a ground control station, a distributed computing system, or the like. Although not depicted, the system 102 may include other components, such as network interfaces, display units, input/output interfaces, operating systems, applications, data storage, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to manage aerial vehicle operations.

In an example, the processor 104 may fetch and execute instructions 108. As a result of the execution of the instructions 110, the system 102 may obtain operation data of planned aerial vehicle operations. The operation data may include operational objective information, aerial vehicle operational parameters, and weather data. In an example, the operational objective information indicates the intended tasks to be performed, including locating and rescuing individuals, mapping a geographical area, monitoring a specified region, extinguishing a fire, or combination thereof. The aerial vehicle operational parameters indicate real-time capabilities of various aerial vehicles, such as speed, altitude limits, fuel capacity, sensor capabilities, and communication range. The weather data may indicate current and forecasted weather related details corresponding to the concerned operational area where the operational task is to be performed.

Once obtained, the instructions 112 may be executed to determine an operational plan based on the operation data. This operational plan may include operational output parameters for selected aerial vehicles, such as flight paths, search patterns, altitude assignments, task allocations, amongst other. The operational plan is designed to achieve the operational objective corresponding to the operational task, which may include tasks such as search and rescue, surveillance, or mapping. The system 102 may employ sophisticated algorithms to optimize the allocation of resources and tasks among the selected aerial vehicles, taking into account their individual capabilities, the terrain characteristics, and the current and forecasted weather conditions.

Once the operational plan is determined, the instructions 114 may be executed to selectively transmit portions of the operational plan to each selected aerial vehicle. This selective transmission ensures that each aerial vehicle receives only the information specific to its role in the operational task. For instance, a particular aerial vehicle may receive data about its designated entry and exit points, assigned search pattern, altitude requirements, and specific operational parameters relevant to its part of operational task. This approach involves transmitting only the necessary information to each aerial vehicle, tailoring the communicated data to the specific tasks and responsibilities assigned to that vehicle within the broader operational plan.

The above functionalities performed as a result of the execution of the instructions 108, may be performed by different programmable entities. Such programmable entities may be implemented through various computing systems, which may be implemented either on a single computing device, or multiple computing devices. As will be explained, various examples of the present subject matter are described in the context of a computing system for managing aerial vehicle operations by using operation data, including operational objectives, vehicle capabilities, and weather information. These and other examples are further described with respect to other figures.

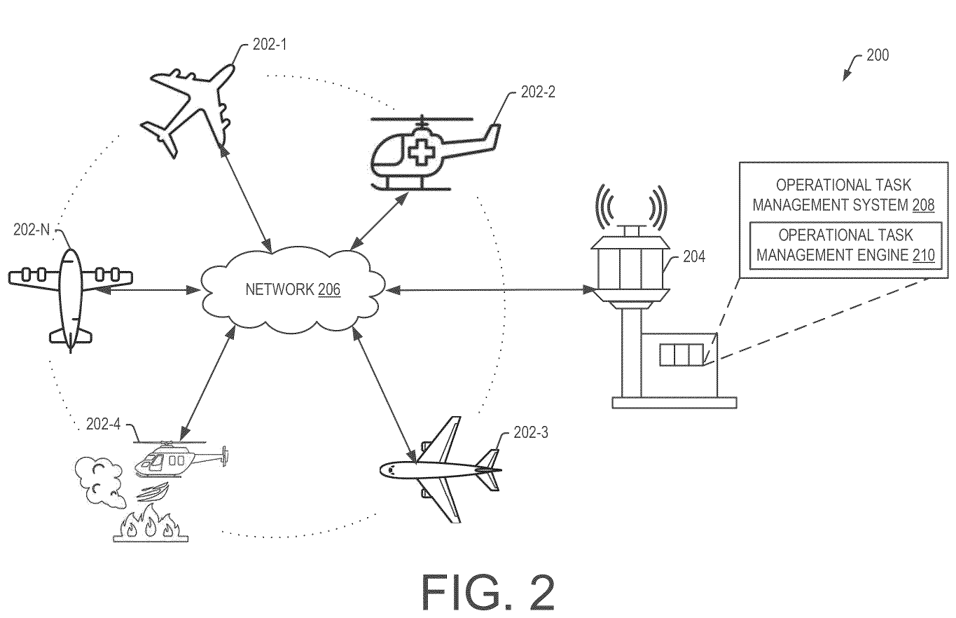

FIG. 2 illustrates an operational task management environment 200 depicting a plurality of aerial vehicles 202-1, 202-2, . . . , 202-N (referred to as aerial vehicle(s) 202) which are configured to achieve an operational objective corresponding to an operational task. The aerial vehicle(s) 202 as shown in the figure represent a diverse fleet of aerial vehicles, including a fixed wing aircraft 202-1, an air ambulance helicopter 202-2, a passenger aircraft 202-3, a firefighting aircraft 202-4, and a transport aircraft 202-N. It may be noted that, above-described aerial vehicles are exemplary, and any other types of aerial vehicles may be used without deviating from the scope of the present subject matter. Such variety of aerial vehicles enables performance of a wide range of operational tasks. Examples of such operational tasks may include, but may not be limited to, aerial surveys, environmental monitoring, disaster response, agricultural inspection, wildlife tracking, forest fire detection, search and rescue operations, border patrol, and maritime surveillance.

As stated earlier as well, each operational task is associated with a specific objective which is to be achieved while performing the operational task to ensure efficiency in the performance of the operational task. For example, a search and rescue mission may aim to locate and rescue individuals in distress within a certain timeframe, here the time constraint is the specific operational objective. Further, while an aerial survey task may focus on mapping a specific geographical area with defined resolution and coverage requirements, here resolution and coverage represents operational objective.

The operational task management environment 200 (referred to as environment 200) further includes a ground station 204 which is communicably coupled with aerial vehicle(s) 202. Such communicable coupling facilitates continuous data exchange between the ground station 204 and the aerial vehicle(s) 202 through various phases of flight of the aerial vehicle(s) 202. In an example, the aerial vehicle(s) 202 are equipped with advanced avionics and communication interface to maintain constant communication with the ground station 204. Further, the ground station 204, represented by a control tower, symbolizes various ground-based entities such as Air Traffic Control (ATC), airliner operations centers, and weather stations. Examples of such ground station 204 include, but are not limited to, ATC facilities, airport management systems, weather information services, Automatic Terminal Information Service (ATIS) stations, flight planning centers, and aircraft maintenance and logistics support systems. The ground station 204 may also be equipped with advanced communication technologies, radar systems, weather monitoring equipment, and data processing capabilities to assist aerial vehicle(s) 202 in safe and efficient operations during performance of operational tasks.

In an example, each of the aerial vehicle(s) 202 are in communication with the ground station 204 through a network 206. Examples of such network 206 that may connect various aerial vehicle(s) 202 with the ground station 204 include, but are not limited to, Aircraft Communications Addressing and Reporting System (ACARS), Very High Frequency (VHF) Data Link (VDL), High Frequency Data Link (HFDL), Satellite Communications (SATCOM) networks, Aeronautical Mobile Airport Communication System (AeroMACS), Controller-Pilot Data Link Communications (CPDLC), Automatic Dependent Surveillance-Contract (ADS-C), and Future Air Navigation System (FANS) networks.

The environment 200 further includes an operational task management system 208 for determining and adapting an operational plan corresponding to each of the aerial vehicle(s) 202 for performance/execution of the operational task. In an example, the operational plan specifies certain instructions for each of the aerial vehicle(s) 202 to achieve the operational objective corresponding to the operation task which is to be performed by the fleet of aerial vehicles. The operational task management system 208 (referred to as system 208) may further include an operational task management engine 210, which performs determination of the operational plan for various aerial vehicle(s) 202. In an example, to determine the operational plan, the operational task management engine 210 (referred to as engine 210) requires operation data representing operational requirements and constraints, vehicle capabilities, and weather conditions from various data sources corresponding to the operational task which needs to be performed. This operation data may include operational objective information, aerial vehicle operational parameters, and weather data. The system 208 utilizes this comprehensive set of data to generate an efficient and effective operational plan tailored to the specific requirements of the task at hand and the capabilities of the available aerial vehicles.

It may be noted that although the system 208 is depicted to have been implemented within the ground station 204, the same may be implemented within any of the aerial vehicle(s) 202 as well. This flexibility in system 208 deployment allows for distributed processing capabilities and enhanced resilience in various operational scenarios. For instance, a lead aircraft may host the system 208, enabling real-time decision-making and coordination even in situations where ground-based communication is limited or unavailable. This approach may provide advantages in terms of reduced latency in decision-making, improved adaptability to changing task conditions, and increased autonomy for the aerial fleet. Additionally, implementing the system 208 on board an aerial vehicle could be particularly beneficial for extended tasks in remote areas or for operations requiring rapid, on-the-fly adjustments to the operational plan. The ability to host the system 208 on either ground-based or airborne platforms enhances the overall versatility and robustness of the aerial operational task management environment.

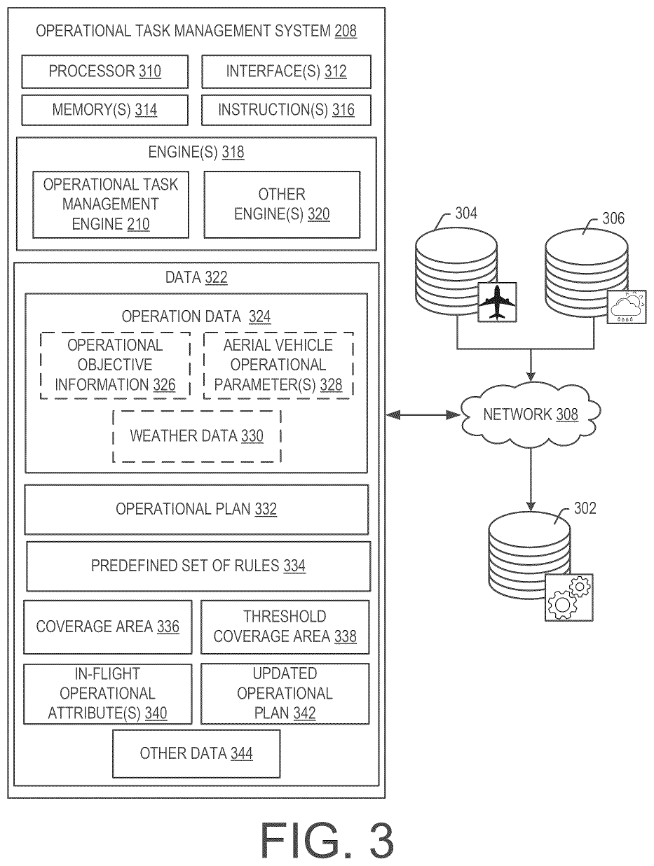

The examples of various data sources and the manner in which the data is obtained from these data sources by the system 208 is depicted in FIG. 3. FIG. 3 further illustrates various functional blocks of the system 208 and how the system 208 is communicatively coupled with various databases, as per an example. The system 208 is coupled with an operational objective database 302, aerial vehicle database 304, and a weather database 306 for obtaining various data which may be required for determination of the operational plan to achieve the operational objective corresponding to the operational task.

In an example, the operational objective database 302 includes details about various operational tasks specifying requirements and constraints of the operational task. This database stores information on different types of operational tasks, such as search and rescue operations, aerial surveys, environmental monitoring, firefighting, and emergency response activities. For each type of operation, the database contains specific parameters like required coverage area, desired search patterns, minimum and maximum altitudes, time constraints, priority levels, and any special equipment or sensor requirements. It also includes information on regulatory constraints, airspace restrictions, and operational protocols specific to each type of operational task. This comprehensive set of task-specific data allows the system to generate tailored operational plans that meet the unique requirements of each operational task while adhering to all relevant operational and safety standards.

Further, the aerial vehicle database 304 includes operational details about different types of aerial vehicles, such as fixed-wing aircraft, rotary-wing aircraft, unmanned aerial vehicles (UAVs), and specialized aerial operation aircraft. This database contains information on each vehicle's specifications, capabilities, and operational parameters. For example, it may include data on maximum speed, cruising speed, fuel capacity, endurance, payload capacity, sensor capabilities, communication range, altitude limitations, and any special equipment or features. The database also stores maintenance schedules, operational history, and current status of each vehicle, enabling the system to make informed decisions about vehicle selection and task allocation.

Lastly, the weather database 306 includes comprehensive meteorological data relevant to aerial operations. This encompasses current weather conditions as well as short-term and long-term forecasts for the operational area. The database stores information on wind speed and direction at various altitudes, temperature profiles, atmospheric pressure, humidity levels, precipitation patterns, cloud cover, visibility ranges, and potential hazards such as turbulence, icing conditions, or severe weather phenomena. It may also include historical weather data and climate patterns to aid in long-term operational task planning and risk assessment.

Various databases are communicably coupled with the system 208 through a network, such as a network 308. The network 308 may be a private network, or a public network and may be implemented as a wired network, a wireless network, or a combination of a wired and wireless network. The network 308 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation network (NGN), Public Switched Telephone Network (PSTN), Long Term Evolution (LTE), and Integrated Services Digital Network (ISDN).

The system 208, as depicted in FIG. 3, includes a processor 310, interface(s) 312 and memory(s) 314. The processor 310 may be implemented as microprocessors, microcomputers, microcontrollers, digital signal processors, central processing units, state machines, logic circuitries, and/or other devices that manipulate signals based on operational instructions. The interface(s) 312 may allow the connection or coupling of the system 208 with one or more other devices, through a wired (e.g., Local Area Network, i.e., LAN) connection or through a wireless connection (e.g., Bluetooth®, Wi-Fi). The interface(s) 312 may also enable intercommunication between different logical as well as hardware components of the system 208. The interface(s) 312 may also enable the system 208 to communicate with other entities, such as various databases, or other devices or systems.

The memory(s) 314 may be a computer-readable medium, examples of which include volatile memory (e.g., RAM), and/or non-volatile memory (e.g., Erasable Programmable read-only memory, i.e., EPROM, flash memory, etc.). The memory(s) 314 may be an external memory, or internal memory, such as a flash drive, a compact disk drive, an external hard disk drive, or the like. The memory(s) 314 may further include data which either may be utilized or generated during the operation of the system 208.

The system 208 may further include instructions 316 and engine(s) 318. In an example, the instructions 316 are fetched from the memory(s) 314 and executed by the processor 310 included within the system 208. The engine(s) 318 may include an operational task management engine, such as engine 210, and other engine(s) 320. The other engine(s) 320 may further implement functionalities that supplement functions performed by the system 208 or any of the engine(s) 318. The engine 210 may be implemented as a combination of hardware and programming, for example, programmable instructions to implement a variety of functionalities. In examples described herein, such combinations of hardware and programming may be implemented in several different ways.

For example, the programming for the engine 210 may be executable instructions, such as instructions 316. Such instructions 316 may be stored on a non-transitory machine-readable storage medium which may be coupled either directly with the system 208 or indirectly (for example, through networked means). In an example, the engine 210 may include a processing resource, for example, either a single processor or a combination of multiple processors, to execute such instructions. In the present examples, the non-transitory machine-readable storage medium may store instructions, such as instructions 316, that when executed by the processing resource, implement the engine 210. In another example, the engine 210 may be implemented as electronic circuitry.

The system 208 may further include a data 322. The data 322 may include corresponding data that is utilized or generated by the system 208, while performing a variety of functions. In an example, the data 322 includes an operation data 324 including an operational objective information 326, aerial vehicle operational parameter(s) 328, and weather data 330, operational plan 332, predefined set of rules 334, coverage area 336, threshold coverage area 338, in-flight operational attribute(s) 340, updated operational plan 342, and other data 344. Further, the other data 344, amongst other things, may serve as a repository for storing data that is processed, or received, or generated as a result of the execution of the instructions by the processor 310.

In an example, the operational objective information 326 is obtained from the operational objective database 302 and include values corresponding to the operational area to be covered, desired search patterns, number and types of aerial vehicles required, location of origin for each vehicle, estimated operation time, desired separation distance between vehicles, and altitude requirements. These parameters define the scope and constraints of the operational task, allowing the system to formulate an appropriate plan.

The aerial vehicle operational parameter(s) 328 is obtained from the aerial vehicle database 304 and include data such as each vehicle's maximum speed, fuel or battery capacity, sensor capabilities, communication range, payload capacity, and any specific operational limitations. This information is crucial for determining the most suitable role and flight path for each aerial vehicle within the overall operational task.

Further, the weather data 330 is obtained from the weather database 306 and includes current and forecasted values for wind speed, wind direction, wind variation, turbulence intensity and location, ambient temperature, atmospheric pressure, cloud cover, visibility range, humidity, precipitation rate, and icing severity. These meteorological factors significantly influence flight performance and safety, and are essential for creating a realistic and adaptable operational plan.

Further, the predefined set of rules 334 includes guidelines for determining efficient routes considering terrain and weather conditions, allocating resources based on vehicle capabilities and operational task requirements, selecting appropriate search patterns for the operational task at hand, establishing coordination protocols for multi-vehicle operations, implementing adaptive planning algorithms to handle changing operational task parameters, conducting risk assessment procedures, defining communication protocols, developing energy management strategies, and creating sensor utilization plans. These rules form the basis for the system's decision-making processes, ensuring that the operational plan is optimized for efficiency, safety, and operational task success while adhering to established best practices and regulatory requirements.

It may be noted that such examples of the various functional blocks as depicted in FIG. 3 are indicative. The present approaches may be applicable to other examples without deviating from the scope of the present subject matter.

The working of the system 208 (via functional blocks as depicted in FIG. 3) is explained in conjunction with various elements of the environment 200 (as described in FIG. 2). In operation, the engine 210 of the system 208 obtains operation data 324 indicating various operational conditions, constraints, and resources from various sources for determining an operational plan for one or more aerial vehicles which are to be selected from the aerial vehicle(s) 202 for execution of the operational task. The operation data 324 includes operational objective information 326 indicating the specific requirements and constraints of the operational task, aerial vehicle operational parameter(s) 328 indicating the capabilities and limitations of each available aerial vehicle, and weather data 330 indicating current and forecasted meteorological conditions in the operational area.

In one example, the operational objective information 326 may be obtained from the operational objective database 302 or the same may be provided by a user operating on a computing device (not shown in FIG. 2) coupled with the system 208. The operational objective information 326 may include values for operational task parameters such as, but may not be limited to, the operational area to be covered, type of operational task, desired search patterns, number of aerial vehicles required, types of aerial vehicles needed, location of origin, desired operation time, separation distance between vehicles, and altitude requirements. For instance, in a search and rescue mission, the operational objective information might specify a 100 square kilometer search area, a grid search pattern, a maximum operation time of 6 hours, and a required minimum altitude of 500 meters above ground level.

Further, the aerial vehicle operational parameter(s) 328 is obtained from the aerial vehicle database 304. The aerial vehicle operational parameter(s) 328 may include information such as each vehicle's maximum speed, fuel or battery capacity, sensor capabilities (e.g., infrared, optical, radar), communication range, payload capacity, and endurance. For example, a fixed-wing aircraft might have a maximum speed of 150 knots, a fuel capacity allowing for 8 hours of flight time, and a communication range of 200 kilometers. Lastly, the weather data 330 is obtained from the weather database 306, and it includes current and forecasted values for wind speed, wind direction, wind variation, turbulence intensity, turbulence location, turbulence timestamp, ambient temperature, atmospheric pressure, cloud cover, visibility range, humidity, precipitation rate, and icing severity.

Once obtained, the engine 210 determines the operational plan 332 for one or more aerial vehicles which are selected from the aerial vehicle(s) 202. In an example, the operational plan 332 specifies instructions for each selected aerial vehicle to achieve the operational objective efficiently and safely. Further, the operational plan 332 includes values for various operational output parameters. Examples of such operational output parameters include, but are not limited to, entry location, exit location, time of departure, time of arrival, attributes representing coverage area, number of aerial vehicles required, search patterns corresponding to each aerial vehicle, flight paths corresponding to each aerial vehicle, speed corresponding to each aerial vehicle, and altitude of operation of each aerial vehicle.

In one example, to determine the operational plan 332, the engine 210 analyze the collected operation data 324 with respect to the predefined set of rules 334. The predefined set of rules 334 are designed to determine optimal flight paths, allocate resources efficiently, establish effective coverage patterns, and coordinate multiple vehicles. In an example, these rules encompass a wide range of considerations crucial for successful aerial operations. Examples of such rules or considerations included within the predefined set of rules 334 include, but are not limited to, rules corresponding to determining efficient routes considering terrain and weather conditions, allocating resources based on vehicle capabilities and operational task requirements, selecting appropriate search patterns for the operational task at hand, establishing coordination protocols for multi-vehicle operations, adaptive planning algorithms to handle changing operational task parameters, risk assessment procedures, communication protocols, energy management strategies, and sensor utilization plans.

During the determination of operational plan 332 based on the predefined set of rules 334, it may be possible that such a situation arises that all the available aerial vehicles, i.e., aerial vehicle(s) 202 may not be required to perform the desired operational task to efficiently achieve the operational objective. This means that even using less number of aerial vehicles may help in achieving the operational objective efficiently. To do so, once operation data 324 is obtained, the engine 210 determines a first coverage area as part of operational plan 332 corresponding to a first aerial vehicle amongst the aerial vehicle(s) 202. In an example, this determination indicates that initially, the engine 210 determines the operational plan 332 for one of the aerial vehicle based on the operation data. The determined first coverage area is stored in coverage area 336 in data 322.

Thereafter, the engine 210 compares the first coverage area (stored within the coverage area 336) with a threshold coverage area 338 to assess whether additional vehicles are needed for performance of the operational task. In an example, the threshold coverage area 338 indicates the coverage area which is required to be covered by the fleet of aerial vehicle(s) 202 to perform the operational task. In one example, the threshold coverage area 338 is the minimum area which is required to be covered.

Based on the comparison, upon determining that the first coverage area cover the threshold coverage area, the engine 210 generates the operational plan 332 including values for various operational output parameters for the first aerial vehicle, i.e., the aerial vehicle which is determined to cover the threshold coverage area 338. Once generated, the engine 210 proceeds to transmit the generated operational plan 332 to the first aerial vehicle.

On the other hand, based on the comparison, upon determining that the first coverage area does not cover the threshold coverage area 338, the engine 210 initiates determination of a second coverage area for a second aerial vehicle. In an example, if the first coverage area does not cover the threshold coverage area, i.e., area covered by first coverage area is not greater than or equal to the threshold coverage area 338, then it is determined by the engine 210 that additional aerial vehicles are required to perform the operational task. This step ensures that the operational area is adequately covered while minimizing resource usage. Further, the second coverage area thus determined is stored in coverage area 336.

Once the second coverage area is determined, the engine 210 then determines a collective coverage area by combining the first coverage area and the second coverage area, i.e., the engine 210 add up the first coverage area with the second coverage area. In an example, the collective coverage area is also stored in coverage area 336. It may be noted that the coverage area 336 includes separate coverage areas corresponding to each aerial vehicle and collective coverage area as well.

After each iteration of determination of coverage area corresponding to an aerial vehicle from the aerial vehicle(s) 202, if the collective coverage area still does not reach the threshold coverage area 338, the engine 210 continues the determination of additional coverage areas corresponding to subsequent aerial vehicles from the aerial vehicle(s) 202 until the collective coverage area reaches the threshold coverage area. Upon determining that the collective coverage area covers the threshold coverage area 338, the engine 210 determines a collective operational plan. In an example, such operational plan comprises values of operational output parameters for the selected aerial vehicles whose coverage areas contribute to the collective coverage area. The collective operational plan specifies instructions for each selected aerial vehicle to achieve the operational objective efficiently. The collective operational plan is also stored in data 322 as part of the operational plan 332.

In an example, the determined operational plan 332 may also include instructions for controlling the light systems of aerial vehicle(s) 202 based on the operation data 324. These instructions may specify the configuration, intensity, direction, and timing of various lighting elements on each aerial vehicle to optimize mission performance and enhance coordination. For instance, during a survey operation, the operational plan 332 may dictate a specific arrangement of light systems across multiple aerial vehicles, coordinating their illumination patterns to maximize visibility and data collection efficiency. This may involve synchronizing searchlights to sweep across designated areas in a predetermined sequence, adjusting beam intensities based on altitude and terrain features, or using coded light signals for inter-vehicle communication. The operational plan 332 may also specify dynamic lighting adjustments in response to changing environmental conditions or mission phases.

Finally, the engine 210 transmits, selectively to each selected aerial vehicle whose coverage area contributes to the collective coverage area, a corresponding portion of the operational plan 332 specific to that aerial vehicle. In an example, the operational plan 332 may include an identifier indicating which portion of operational plan corresponds to which aerial vehicle. Then, the engine 210 using that identifier, identify the relevant aerial vehicle and transmit the corresponding portion of the operational plan to respective aerial vehicle. It may be noted that, the selective transmission of operational plan 332 to selected aerial vehicles may be performed using any other approach without deviating from the scope of the present subject matter. Such selective and targeted distribution of information ensures that each vehicle has the necessary instructions to carry out its part of the operational task without being burdened with extraneous data.

Once transmitted, the corresponding portion of the operational plan 332 may be utilized by respective aerial vehicle to perform the operational task. During the performance of the operational task, it may be possible that some of the aerial vehicles, which are selected to perform the operational task, are underachieving or overachieving the tasks assigned to them. In such a case, the portion of the operational plan 332 corresponding to each aerial vehicle needs to be revised to maintain overall operational task efficiency and effectiveness. This means that, during the operational task, the engine 210 continuously monitors the performance of aerial vehicle(s) 202 in their respective operational task.

To do so, the engine 210 of the system 208 continuously receives real-time values corresponding to a plurality of in-flight operational attributes from each selected aerial vehicle during the execution of the operational task. These real-time values are stored in data 322 in in-flight operational attribute(s) 340. Examples of such in-flight operational attributes may include, but are not limited to, current position, altitude, speed, heading, fuel level, battery charge level, sensor status, communication signal strength, detected obstacles, weather conditions encountered, operational task progress indicators, equipment status, and payload status.

Once the real-time values corresponding to the in-flight operational attribute(s) 340 are received, the engine 210 determines ideal values corresponding to the in-flight operational attribute(s) 340. In an example, the ideal values corresponding to the in-flight operational attribute(s) 340 are determined based on the time elapsed from the start of the operational task till the current stage of the operational task. The ideal values corresponding to the in-flight operational attribute(s) 340 indicates expected progress or status at that point in the operational task.

Thereafter, the real-time values of the in-flight operational attribute(s) 340 are compared with the ideal values corresponding to those attributes. In an example, such comparison allows the engine 210 to assess how well each aerial vehicle is performing relative to the planned operational parameters. This comparison is for identifying any deviations from the expected performance, which may impact the overall operational task efficiency and effectiveness. By continuously monitoring and evaluating these real-time values against ideal benchmarks, the engine 210 may detect potential issues early, such as unexpected delays, resource constraints, or environmental challenges that may require adjustments to the operational plan.

Upon determining that the real-time values fail to achieve the ideal value corresponding to that in-flight operational attributes, i.e., the concerned aerial vehicle is either underachieving the task or overachieving the task assigned to that aerial vehicle, the engine 210 initiates a process to determine the updated operational plan 342 including updated values for the operational output parameters for each of the selected aerial vehicles. This update aims to optimize the completion of the operational task given the current situation.

For example, in a firefighting operation, if a water-dropping aircraft is experiencing lower water dispersal rates than expected due to unexpected thermal updrafts, the system might update its flight path to include more frequent water refill stops, adjust its drop altitude, or reassign part of its coverage area to another aircraft. Similarly, if a fire mapping drone is covering ground faster than anticipated due to favorable wind conditions, the system might expand its survey area or reassign it to provide real-time intelligence to ground crews in more critical zones.

In an air ambulance service scenario, if a medical evacuation helicopter is delayed due to unforeseen weather conditions, the system might reroute it to a closer landing zone, dispatch a ground ambulance to meet it at an alternate location, or reassign the operational task to another available air ambulance. Conversely, if an air ambulance completes an operational task ahead of schedule, the system 208 might immediately redirect it to assist with another nearby emergency or position it strategically to improve overall response times in high-risk areas.

The process of determining the updated values takes into account the current status of all vehicles, the remaining objectives of the operational task, and any changes in environmental conditions. This may involve recalculating optimal routes, reassigning search areas, adjusting flight altitudes, or even bringing additional vehicles into the operation if necessary.

Once the updated operational plan 342 is determined, the engine 210 of the system 208 transmits these updates to the relevant aerial vehicles. Such transmission is also selective in nature, i.e., the portion of updated operational plan 342 is transmitted to only those aerial vehicles whose operation is required to be modified or adjusted. This selective transmission approach minimizes unnecessary communication and processing overhead for vehicles that can continue their current operations unchanged. By targeting only the affected vehicles, the system ensures efficient use of communication bandwidth and reduces the risk of confusion or conflicting instructions. This allows for real-time adjustment of the operational plan, ensuring that the overall operational task objectives can still be met despite individual vehicles over- or under-performing.

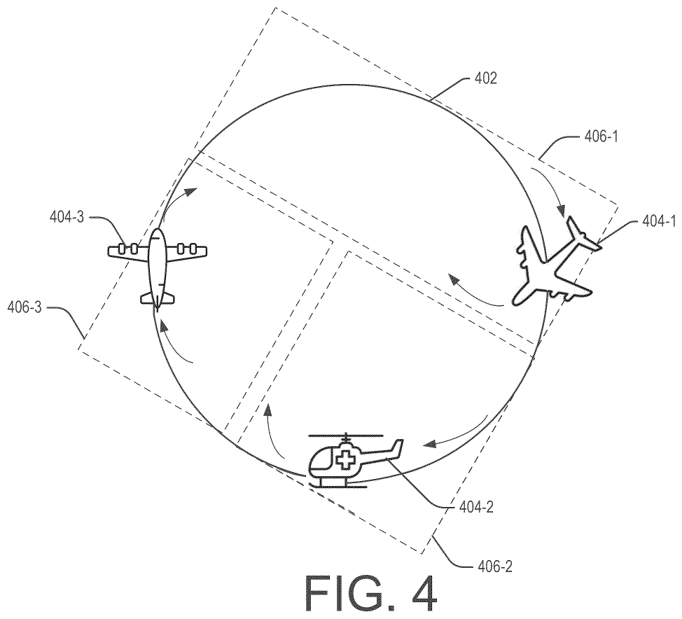

FIG. 4 illustrates a coordinated multi-aerial vehicle operation within a defined operational area 402, as per an example. In an example, the operational area 402 is for executing an operational task that requires comprehensive coverage and coordination among multiple aerial vehicles. Specifically, FIG. 4 demonstrates how the system 208 efficiently divides and assigns different sections of the operational area 402 to multiple aerial vehicles for comprehensive coverage.

As depicted in FIG. 4, the operational area 402 is systematically partitioned into distinct sectors, each assigned to a specific aerial vehicle. For example, three different types of aerial vehicles are shown in FIG. 4, i.e., a fixed-wing aircraft (first aerial vehicle 404-1), a helicopter for medical purposes (second aerial vehicle 404-2), and a transport or surveillance aircraft (third aerial vehicle 404-3). Each aerial vehicle is provided with an operational plan restricting their operation in their respective coverage area, i.e., 406-1, 406-2, and 406-3, that is planned to avoid overlap while ensuring complete coverage of the operational area 402.

The coverage areas, represented by dashed lines and directional arrows, illustrate how each aerial vehicle's route or coverage area is tailored to its capabilities, the terrain features, and the weather conditions in its assigned sector. The first aerial vehicle 404-1, likely a high-speed fixed-wing aircraft, covers the largest portion on the right side of the operational area 402. Such assignment leverages the vehicle's ability to efficiently cover vast, open areas with long, sweeping parallel tracks. The second aerial vehicle 404-2, being a medical purpose helicopter, is assigned to the central portion of the operational area. This region may contain more complex terrain or require more detailed searches, tasks well-suited to a helicopter's maneuverability and ability to hover. The third aerial vehicle 404-3 covers the left portion of the operational area 402. This mixed approach suggests a versatile aerial vehicle capable of both wide-area surveillance and detailed inspection, perhaps adapting to varied terrain or weather conditions within its assigned coverage area. By matching each vehicle's strengths to the specific challenges of its assigned area, the system 208 maximizes the efficiency and effectiveness of the overall operation.

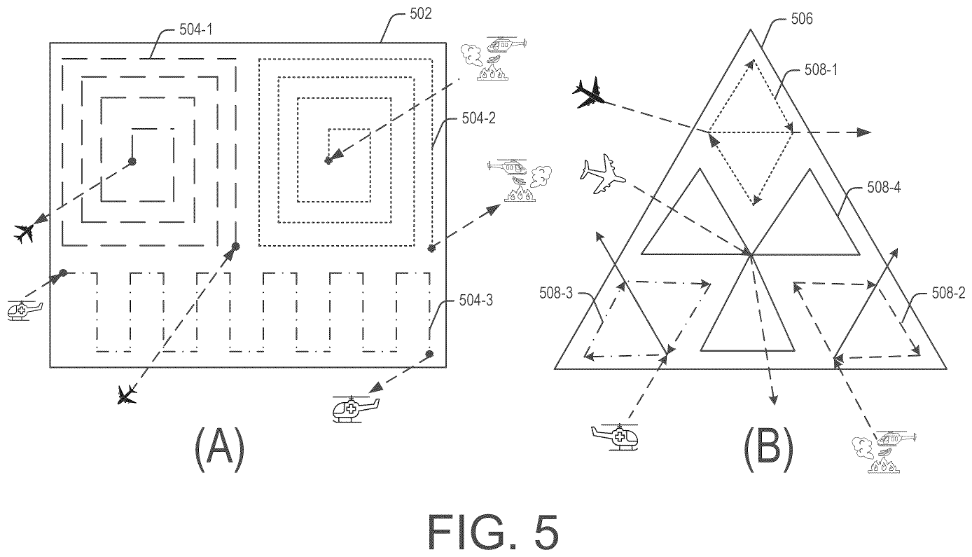

FIG. 5A-5B illustrates allocation of specific search patterns and/or search paths to various aerial vehicles as part of the operational plan that may be employed depending on the specific requirements of the operational task. FIG. 5A depicts operational area 502 which is divided into three distinct coverage area with respective search patterns to be followed by respective allocated aerial vehicles. For example, first coverage area includes a spiral pattern 504-1, second coverage area includes an expanding square pattern 504-2, and the third coverage area includes a parallel track pattern 504-3. It may be noted that, such allocation of distinct search patterns to respective coverage areas is done by system 208 based on various factors including the specific capabilities of each aerial vehicle, the terrain characteristics within each coverage area, the nature of the operational task, current and forecasted weather conditions, and the overall task objectives. The system 208 analyzes these factors to optimize the search efficiency and effectiveness for each aerial vehicle while ensuring comprehensive coverage of the entire operational area.

In an example, the spiral pattern 504-1 demonstrates an inward-moving spiral trajectory, which may be particularly effective for focused searches starting from the perimeter of an area and moving towards its center. Such a pattern might be used when the probability of finding a target is believed to be higher near the center of the search area. The expanding square pattern 504-2 shows an outward-expanding square search pattern. This pattern is useful for situations where the search needs to start from a central point and gradually expand outward, maintaining a systematic and thorough coverage of the area. Lastly, the parallel track pattern 504-3 displays a systematic back-and-forth movement across the search area. This pattern is highly efficient for covering large, open areas where a uniform sweep is required, such as in agricultural surveys or wide-area environmental monitoring.

FIG. 5B depicts an operational area 506 which is divided into four distinct coverage areas, each associated with a specific aerial vehicle and its corresponding flight path. The operational area is triangular in shape, allowing for an efficient division of the search space among multiple aerial vehicles.

Each coverage area within the operational area 506 is assigned a unique flight path, denoted as 508-1, 508-2, 508-3, and 508-4. These flight paths are carefully designed to specify both entry and exit points for the corresponding aerial vehicles. The entry points, typically located at the outer edges of the operational area, serve as the starting positions for each vehicle's operational task. Conversely, the exit points, which may be at the center or another strategic location within the coverage area, mark the completion of each vehicle's assigned task. This clear definition of entry and exit points ensures a structured and organized approach to the overall operational task.

The determination of these flight paths is crucial for maintaining a safe separating distance between all aerial vehicles throughout the operation. By assigning distinct coverage areas and non-overlapping flight paths, the system minimizes the risk of mid-air collisions or interference between vehicles. Furthermore, this strategic division and allocation of flight paths ensure that the entire operational area is covered in a timely and efficient manner. Each aerial vehicle can focus on its designated sector, eliminating redundant coverage and optimizing the use of available resources. This approach not only enhances the safety of the operation but also significantly improves the overall efficiency and effectiveness of the multi-aerial vehicle operational task within the given operational area.

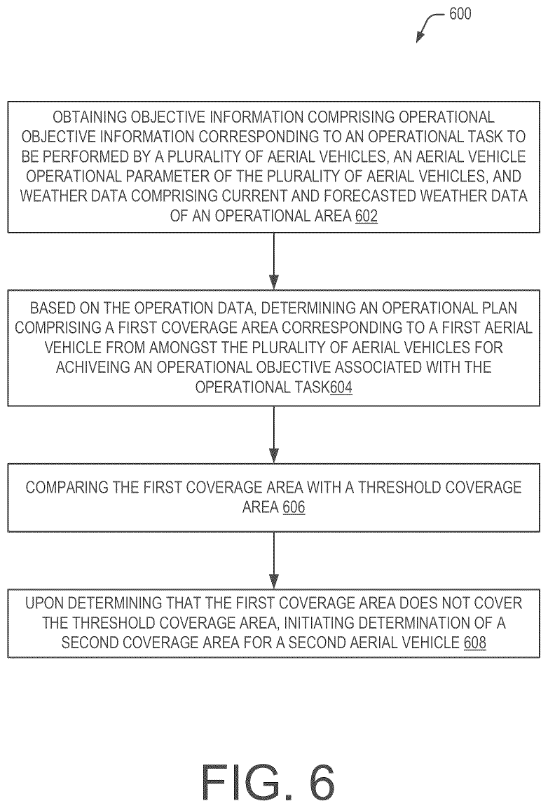

FIG. 6 illustrates a method 600 for determining an operation plan corresponding to a plurality of aerial vehicles, as per an example. The operation plan specify instructions for the selected aerial vehicles, when followed by a pilot, ensures an operational objective is achieved in efficient manner. The order in which the method 600 is described is not intended to be construed as a limitation, and some of the described method blocks may be combined in a different order to implement the method, or an alternative method.

Furthermore, the method 600 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 600 may be implemented by an operational task management system, such as system 208, as shown in FIG. 2 and FIG. 3. In an implementation, the method may be performed under an “as a service” delivery model, where the system 208, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 600 may be implemented by the system 208 for determining an operational plan including a value of an operational output parameter for one or more aerial vehicles. At block 602, operation data including operational objective information, aerial vehicle operational parameters, and weather data is obtained. For example, the engine 210 of the system 208 obtains operation data 324 indicating various operational conditions, constraints, and resources from various sources for determining an operational plan for one or more aerial vehicles which are selected from the aerial vehicle(s) 202. The operation data 324 includes operational objective information 326 indicating the specific requirements and constraints of the operational task, aerial vehicle operational parameter(s) 328 indicating the capabilities and limitations of each available aerial vehicle, and weather data 330 indicating current and forecasted meteorological conditions in the operational area.

At block 604, based on the operation data, an operational plan including a first coverage area corresponding to a first aerial vehicle amongst the plurality of aerial vehicle is determined. For example, the engine 210 determines the operational plan 332 for one or more aerial vehicles which are selected from the aerial vehicle(s) 202. In an example, the operational plan 332 specifies instructions for each selected aerial vehicle to achieve the operational objective efficiently and safely. Further, the operational plan 332 includes values for various operational output parameters. Examples of such operational output parameters include, but are not limited to, entry location, exit location, time of departure, time of arrival, attributes representing coverage area, search patterns corresponding to each aerial vehicle, and the number of aerial vehicles required for the operational task.

During the determination of operational plan 332 based on the predefined set of rules 334, it may be possible that such a situation arise that all the available aerial vehicles, i.e., aerial vehicle(s) 202 may not be required to perform the desired operational task to efficiently achieve the operational objective. This means that even using less number of aerial vehicles may help in achieving the operational objective efficiently. To do so, once operation data 324 is obtained, the engine 210 determines a first coverage area as part of operational plan 332 corresponding to a first aerial vehicle amongst the aerial vehicle(s) 202. In an example, this determination indicate that initially, the engine 210 determines the operational plan 332 for one of the aerial vehicle based on the operation data. The determined first coverage area is stored in coverage area 336 in data 322.

At block 606, the first coverage area is compared with a threshold coverage area. For example, the engine 210 compares the first coverage area (stored within the coverage area 336) with a threshold coverage area 338 to assess whether additional vehicles are needed for performance of the operational task. In an example, the threshold coverage area 338 indicates the coverage area which is required to be covered by the fleet of aerial vehicle(s) 202 to perform the operational task. In one example, the threshold coverage area 338 is the minimum area which is required to be covered.

At block 608, upon determining that the first coverage area does not cover the threshold coverage area, determination of a second coverage area for a second aerial vehicle is initiated. For example, the engine 210 transmits, selectively to each selected aerial vehicle whose coverage area contributes to the collective coverage area, a corresponding portion of the operational plan 332 specific to that aerial vehicle. In an example, collective operational plan may include an identifier indicating which portion of operational plan corresponds to which aerial vehicle. Then, the engine 210 using that identifier, identify the relevant aerial vehicle and transmit the corresponding portion of the operational plan to respective aerial vehicle. It may be noted that, the selective transmission of operational plan 332 to selected aerial vehicles may be performed using any other approach without deviating from the scope of the present subject matter. Such selective and targeted distribution of information ensures that each vehicle has the necessary instructions to carry out its part of the operational task without being burdened with extraneous data.

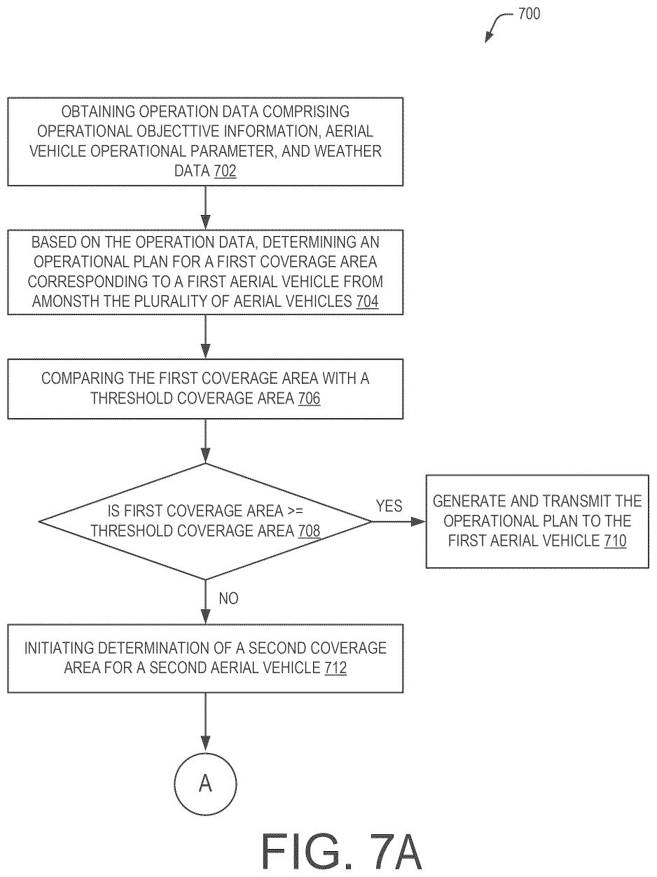

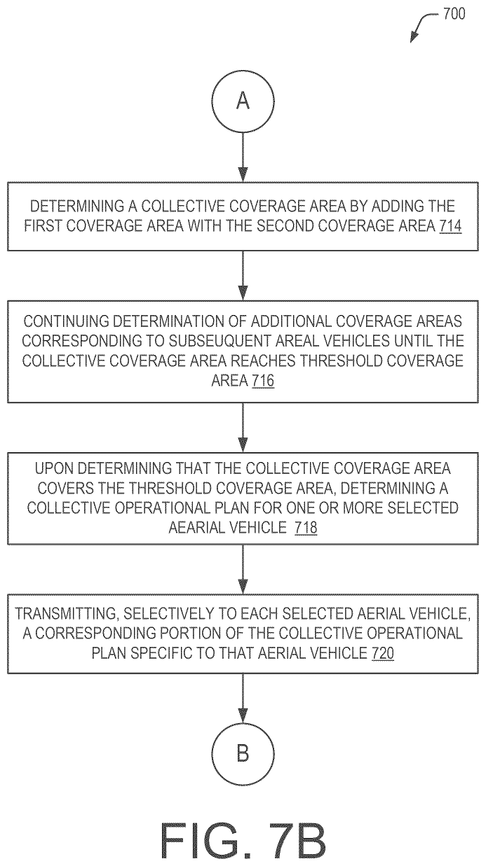

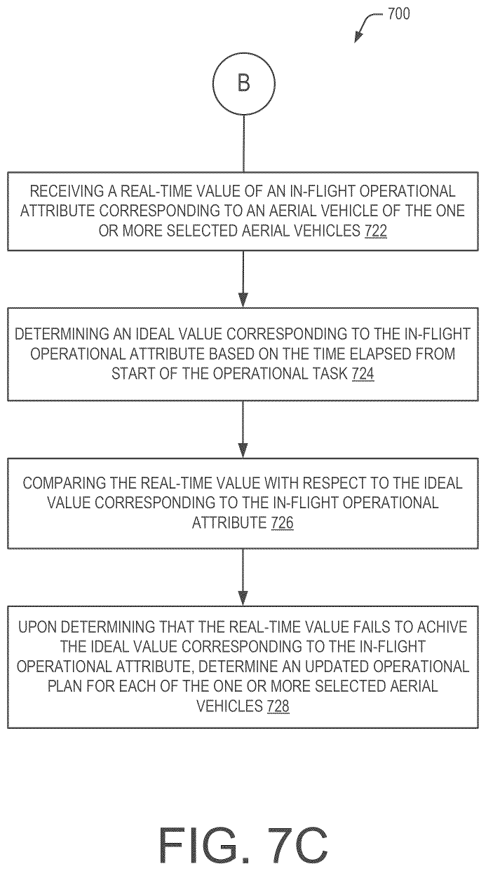

FIG. 7 illustrates a method 700 for determining and adapting an operational plan corresponding to a plurality of aerial vehicles during execution of an operational task, as per an example. The order in which the method 700 is described is not intended to be construed as a limitation, and some of the described method blocks may be combined in a different order to implement the method, or an alternative method.

Furthermore, the method 700 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 700 may be implemented by an operational task management system, such as system 208, as shown in FIG. 2 and FIG. 3. In an example implementation, the method may be performed under an “as a service” delivery model, where the system 208, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 700 may be implemented by the system 208, before and during execution of the operational task, for determining and adapting an operation plan corresponding to a plurality of aerial vehicles. At block 702, operation data including operational objective information, aerial vehicle operational parameter, and weather data is obtained. For example, the engine 210 of the system 208 obtains operation data 324 indicating various operational conditions, constraints, and resources from various sources for determining an operational plan for one or more aerial vehicles which are selected from the aerial vehicle(s) 202. The operation data 324 includes operational objective information 326 indicating the specific requirements and constraints of the operational task, aerial vehicle operational parameter(s) 328 indicating the capabilities and limitations of each available aerial vehicle, and weather data 330 indicating current and forecasted meteorological conditions in the operational area.

At block 704, an operational plan comprising a first coverage area corresponding to a first aerial vehicle from amongst the plurality of aerial vehicles is determined based on the operation data. For example, the engine 210 determines the operational plan 332 for one or more aerial vehicles which are selected from the aerial vehicle(s) 202. In an example, the operational plan 332 specifies instructions for each selected aerial vehicle to achieve the operational objective efficiently and safely. Further, the operational plan 332 includes values for various operational output parameters. Examples of such operational output parameters include, but are not limited to, entry location, exit location, time of departure, time of arrival, attributes representing coverage area, number of aerial vehicles required, search patterns corresponding to each aerial vehicle, flight paths corresponding to each aerial vehicle, speed corresponding to each aerial vehicle, and altitude of operation of each aerial vehicle.

During the determination of operational plan 332 based on the predefined set of rules 334, it may be possible that such a situation arises that all the available aerial vehicles, i.e., aerial vehicle(s) 202 may not be required to perform the desired operational task to efficiently achieve the operational objective. This means that even using a smaller number of aerial vehicles may help in achieving the operational objective efficiently. To do so, once operation data 324 is obtained, the engine 210 determines a first coverage area as part of operational plan 332 corresponding to a first aerial vehicle amongst the aerial vehicle(s) 202. In an example, this determination indicates that initially, the engine 210 determines the operational plan 332 for one of the aerial vehicles based on the operation data. The determined first coverage area is stored in coverage area 336 in data 322.

At block 706, the first coverage area is compared with a threshold coverage area. For example, the engine 210 compares the first coverage area (stored within the coverage area 336) with a threshold coverage area 338 to assess whether additional vehicles are needed for performance of the operational task. In an example, the threshold coverage area 338 indicates the coverage area which is required to be covered by the fleet of aerial vehicle(s) 202 to perform the operational task. In one example, the threshold coverage area 338 is the minimum area which is required to be covered.

At block 708, a determination is made as to whether the first coverage area is greater than or equal to the threshold coverage area or not. For example, based on the comparison, the engine 210 determines whether the first coverage area is greater than or equal to the threshold coverage area. In an example, upon determining that the first coverage area cover the threshold coverage area, i.e., the first coverage area is greater than or equal to threshold coverage area, the method 700 proceeds to block 710 (‘Yes’ path from block 708). On the other hand, upon determining that the first coverage area does not cover the threshold coverage area, i.e., the first coverage area is less than the threshold coverage area, the method 700 proceeds to block 712 (‘No’ path from block 708).

At block 710, operational plan comprising the first coverage area is generated and transmitted to the first aerial vehicle. For example, upon determining that the first coverage area cover the threshold coverage area, the engine 210 generates the operational plan 332 including values for various operational output parameters for the first aerial vehicle, i.e., the aerial vehicle which is determined to cover the threshold coverage area 338. Once generated, the engine 210 proceeds to transmit the generated operational plan 332 to the first aerial vehicle.

At block 712, determination of a second coverage area for a second aerial vehicle is initiated. For example, upon determining that the first coverage area does not cover the threshold coverage area 338, the engine 210 initiates determination of a second coverage area for a second aerial vehicle. In an example, if the first coverage area does not cover the threshold coverage area, i.e., area covered by first coverage area is not greater than or equal to the threshold coverage area 338, then it is determined by the engine 210 that additional aerial vehicles are required to perform the operational task. This step ensures that the operational area is adequately covered while minimizing resource usage. Further, the second coverage area thus determined is stored in coverage area 336.

At block 714, a collective coverage area is determined by adding the first coverage area with the second coverage area. For example, the engine 210 then determines a collective coverage area by combining the first coverage area and the second coverage area, i.e., the engine 210 add up the first coverage area with the second coverage area. In an example, the collective coverage area is also stored in coverage area 336. It may be noted that the coverage area 336 includes separate coverage areas corresponding to each aerial vehicle and collective coverage area as well.

At block 716, determination of additional coverage areas corresponding to subsequent aerial vehicles continued until the collective coverage area reaches threshold coverage area. For example, After each iteration of determination of coverage area corresponding to an aerial vehicle from the aerial vehicle(s) 202, if the collective coverage area still does not reach the threshold coverage area 338, the engine 210 continues the determination of additional coverage areas corresponding to subsequent aerial vehicles from the aerial vehicle(s) 202 until the collective coverage area reaches the threshold coverage area.

At block 718, upon determining that the collective coverage area covers the threshold coverage area, a collective operational plan for one or more selected aerial vehicle is determined. For example, upon determining that the collective coverage area covers the threshold coverage area 338, the engine 210 determines a collective operational plan. In an example, such operational plan comprises values of operational output parameters for the selected aerial vehicles whose coverage areas contribute to the collective coverage area. The collective operational plan specifies instructions for each selected aerial vehicle to achieve the operational objective efficiently. The collective operational plan is also stored in data 322 as part of the operational plan 332.

At block 720, a corresponding portion of the collective operational plan is transmitted selectively to each selected aerial vehicle which is specific to that aerial vehicle. For example, the engine 210 transmits, selectively to each selected aerial vehicle whose coverage area contributes to the collective coverage area, a corresponding portion of the operational plan 332 specific to that aerial vehicle. In an example, collective operational plan may include an identifier indicating which portion of operational plan corresponds to which aerial vehicle. Then, the engine 210 using that identifier, identify the relevant aerial vehicle and transmit the corresponding portion of the operational plan to respective aerial vehicle. It may be noted that, the selective transmission of operational plan 332 to selected aerial vehicles may be performed using any other approach without deviating from the scope of the present subject matter. Such selective and targeted distribution of information ensures that each vehicle has the necessary instructions to carry out its part of the operational task without being burdened with extraneous data.

Once transmitted, the corresponding portion of the operational plan 332 may be utilized by respective aerial vehicle to perform the operational task. During the performance of the operational task, it may be possible that some of the aerial vehicles, which are selected to perform the operational task, are underachieving or overachieving the tasks assigned to them. In such a case, the portion of the operational plan 332 corresponding to each aerial vehicle needs to be revised to maintain overall operational task efficiency and effectiveness. This means that, during the operational task, the engine 210 continuously monitors the performance of aerial vehicle(s) 202 in their respective operational task.

At block 722, a real-time value of an in-flight operational attribute corresponding to an aerial vehicle of the one or more selected aerial vehicle is received. For example, the engine 210 of the system 208 continuously receives real-time values corresponding to a plurality of in-flight operational attributes from each selected aerial vehicle during the execution of the operational task. These real-time values are stored in data 322 in in-flight operational attribute(s) 340. Examples of such in-flight operational attributes may include, but are not limited to, current position, altitude, speed, heading, fuel level, battery charge level, sensor status, communication signal strength, detected obstacles, weather conditions encountered, operational task progress indicators, equipment status, and payload status.

At block 724, an ideal value corresponding to the in-flight operational attribute is determined based on the time elapsed from the start of the operational task. For example, the engine 210 determines ideal values corresponding to the in-flight operational attribute(s) 340. In an example, the ideal values corresponding to the in-flight operational attribute(s) 340 are determined based on the time elapsed from the start of the operational task till the current stage of the operational task. The ideal values corresponding to the in-flight operational attribute(s) 340 indicates expected progress or status at that point in the operational task.

At block 726, the real-time value is compared with respect to the ideal value corresponding to the in-flight operational attribute. For example, the real-time values of the in-flight operational attribute(s) 340 are compared with the ideal values corresponding to those attributes. In an example, such comparison allows the engine 210 to assess how well each aerial vehicle is performing relative to the planned operational parameters. This comparison is for identifying any deviations from the expected performance, which may impact the overall operational task efficiency and effectiveness. By continuously monitoring and evaluating these real-time values against ideal benchmarks, the engine 210 may detect potential issues early, such as unexpected delays, resource constraints, or environmental challenges that may require adjustments to the operational plan.

At block 728, upon determining that the real-time value fails to achieve the ideal value corresponding to the in-flight operational attribute, an updated operational plan for each of the one or more selected aerial vehicles is determined. For example, Upon determining that the real-time values fail to achieve the ideal value corresponding to that in-flight operational attributes, i.e., the concerned aerial vehicle is either underachieving the task or overachieving the task assigned to that aerial vehicle, the engine 210 initiates a process to determine the updated operational plan 342 including updated values for the operational output parameters for each of the selected aerial vehicles. This update aims to optimize the completion of the operational task given the current situation.

For example, in a firefighting operation, if a water-dropping aircraft is experiencing lower water dispersal rates than expected due to unexpected thermal updrafts, the system might update its flight path to include more frequent water refill stops, adjust its drop altitude, or reassign part of its coverage area to another aircraft. Similarly, if a fire mapping drone is covering ground faster than anticipated due to favorable wind conditions, the system might expand its survey area or reassign it to provide real-time intelligence to ground crews in more critical zones.

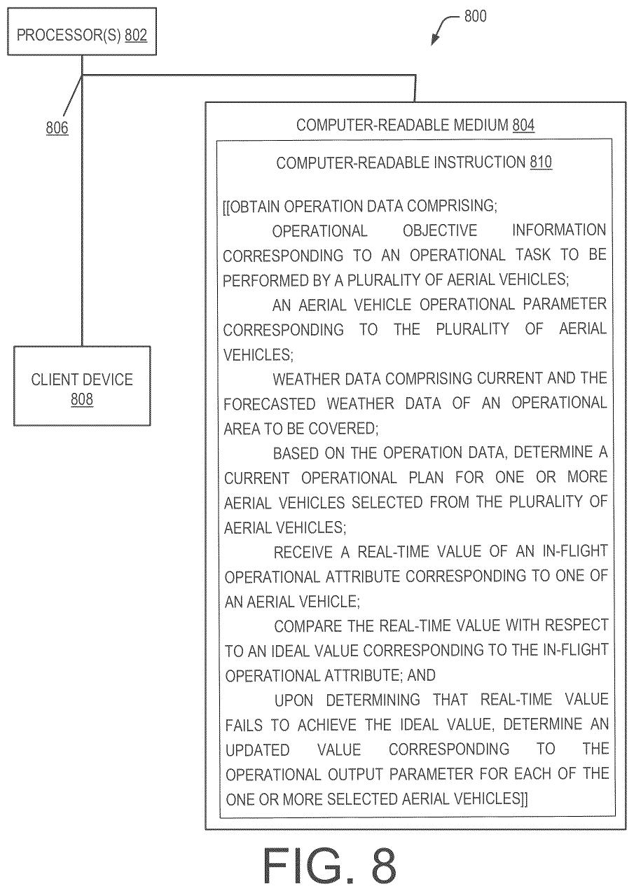

FIG. 8 illustrates a computing environment 800 implementing a non-transitory computer-readable medium for determining and adapting an operational plan for aerial vehicles to achieve an operational objective associated with an operational task. In an example, the computing environment 800 includes processor(s) 802 communicatively coupled to a non-transitory computer-readable medium 804 through a communication link 806. The processor(s) 802 may have one or more processing resources for fetching and executing computer readable instructions from the non-transitory computer readable medium 804.

The non-transitory computer readable medium 804 may be, for example, an internal memory device or an external memory device. In an example implementation, the communication link 806 may be a network communication link. The processor(s) 802 and the non-transitory computer readable medium 804 may also be communicatively coupled to a computing device 808 over the network.

In an example implementation, the non-transitory computer readable medium 804 includes a set of computer readable instructions 810 (referred to as instructions 810) which may be accessed by the processor(s) 802 through the communication link 806. Referring to FIG. 8, in an example, the non-transitory computer readable medium 804 includes instructions 810 that cause the processor(s) 802 to obtain operation data, such as operation data 324, including operational objective information 326, aerial vehicle operational parameter(s) 328, and weather data 330. In an example, to collect such various data, the instructions 810 cause the processor(s) 802 to interface with various databases and real-time data feeds to gather comprehensive information about the operational task requirements and constraints, aerial vehicle capabilities, and environmental conditions.

Thereafter, the instructions 810 cause the processor(s) 802 to determine an operational plan 332 based on the operation data 324. The operation plan 332 specifies instructions for each selected aerial vehicle to achieve the operational objective. In an example, the operational plan 332 is determined by analyzing the operation data 324 with respect to various predefined set of rules. The plan determination process involves complex algorithms that consider multiple factors simultaneously, such as operational task priorities, aerial vehicle capabilities, fuel efficiency, and risk mitigation. The resulting operational plan provides detailed guidance for each vehicle, including flight paths, altitudes, speeds, task assignments, and many more. Once the operational plan is determined, the instructions 810 cause the processor(s) 802 to transmit selectively a corresponding portion of the operational plan 332 to specific aerial vehicles who has been selected for performance of the operational task.

Continuing further, the instructions 810 cause the processor(s) 802 to receive a real-time value of the in-flight operational attribute(s) 340 for a selected aerial vehicle amongst the aerial vehicles who are performing the operational task. In an example, such reception of real-time data is continuous from each vehicle to the system implementing the management of operational plan. Examples of in-flight operational attribute(s) 340 may include current position, altitude, speed, heading, fuel level, battery charge level, sensor status, communication signal strength, detected obstacles, weather conditions encountered, operational task progress indicators, equipment status, payload status, or combinations thereof.

Thereafter, the instructions 810 cause the processor(s) 802 to analyze the real-time value with respect to an ideal value corresponding to the in-flight operational attribute. In an example, such analysis involves comparing the actual performance of each vehicle against its expected performance at that point in the operational task. The ideal value corresponding to the in-flight operational attribute may be determined based on time elapsed from the start of the operational task. As a result of this comparison, the processor(s) 802 identifies any deviations from the planned performance and assess their potential impact on the overall operational task.

The instructions 810 then cause the processor(s) 802 to determine, upon finding that the real-time value either fails to achieve or over achieve the ideal value, updated operational plan 342 comprising updated value for the operational output parameter for each selected aerial vehicle. In an example, determination of updated operational plan 342 involves recalculating various aspects of the operational task to accommodate the observed deviations. The operational output parameters that may be updated include entry location, exit location, time of departure, time of arrival, attributes representing coverage area, number of aerial vehicles required, search patterns corresponding to each aerial vehicle, flight paths corresponding to each aerial vehicle, speed corresponding to each aerial vehicle, and altitude of operation of each aerial vehicle, or combinations thereof.

Additionally, the instructions 810 may cause the processor(s) 802 to transmit the updated operational plan 342 to the relevant aerial vehicles, allowing for real-time adjustment of the task execution. Such transmission is caused to ensure that each aerial vehicle receives timely updates tailored to its specific role in the operational task. Such adaptive approach ensures that the overall operational task objectives may still be met despite individual vehicles over- or under-performing, or in the face of changing environmental conditions. By continuously updating and optimizing the operational plan 332, the processor(s) 802 may maintain operational task effectiveness even in highly dynamic and unpredictable environments.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain operation data comprising:
operational objective information corresponding to an operational task to be performed by a plurality of aerial vehicles, wherein the operational objective information comprises a value of a operational task parameter specifying requirements and constraints of the operational task;
an aerial vehicle operational parameter corresponding to the plurality of aerial vehicles indicating operational capability of each of the plurality of aerial vehicles; and
weather data comprising current weather data and forecasted weather data of an operational area to be covered by the plurality of aerial vehicles for executing the operational task;
based on the operation data, determine an operational plan comprising a value of an operational output parameter for one or more aerial vehicles selected from the plurality of aerial vehicles, wherein the operational plan specifies instructions for each selected aerial vehicle to achieve an operational objective; and
cause to transmit, selectively to each selected aerial vehicle, corresponding portion of the operational plan specific to that aerial vehicle.

2. The system of claim 1, wherein:
the operational task is one of a survey, remote sensing operations, payload delivery, air ambulance service, environmental monitoring, emergency response activities, and surveillance and reconnaissance; and
the operational objective is one of locating and rescuing individuals on time, mapping a geographical area efficiently, monitoring a specified region with less resources, extinguishing a fire in timely manner, or combination thereof.

3. The system of claim 1, wherein the operational task parameter is one of the operational area, type of operational task, a desired search pattern, number of aerial vehicles, types of aerial vehicles, location of origin, desired operation time, altitude, or combination thereof.

4. The system of claim 1, wherein the weather data comprises values corresponding to a wind speed, a wind direction, a wind variation, a turbulence intensity, a turbulence location, a turbulence timestamp, an ambient temperature, an atmospheric pressure, a cloud cover, a visibility range, a humidity, a precipitation rate, an icing severity, or combination thereof.

5. The system of claim 1, wherein the operational output parameter is one of entry location, exit location, time of departure, time of arrival, attributes representing coverage area, number of aerial vehicles, search patterns corresponding to each aerial vehicle, flight paths corresponding to each aerial vehicle, speed corresponding to each aerial vehicle, altitude of operation of each aerial vehicle or combination thereof.

6. The system of claim 1, wherein to determine the operational plan, the instructions are executable by the processor to:
analyze the data comprised within the operation data with respect to a predefined set of rules to determine the operational plan corresponding to one or more aerial vehicles selected from the plurality of aerial vehicles,
wherein the predefined set of rules indicates optimal flight paths, resource allocation, coverage patterns, and coordination strategies based on the operational task parameter, aerial vehicle operational parameter, and weather data, wherein the predefined set of rules comprises rules corresponding to determining efficient routes considering terrain and weather conditions, allocating resources based on vehicle capabilities and operational task requirements, selecting appropriate search patterns for the operational task at hand, establishing coordination protocols for multi-vehicle operations, adaptive planning algorithms to handle changing operational task parameters, risk assessment procedures, communication protocols, energy management strategies, and sensor utilization plans.

7. The system of claim 1, wherein the aerial vehicle operational parameter is one of an aerial vehicle speed, a fuel capacity, sensor capabilities, a communication range, or combination thereof.

8. A method comprising:
obtaining operation data comprising:
operational objective information corresponding to an operational task to be performed by a plurality of aerial vehicles, wherein the operational objective information comprises a value of a operational task parameter specifying requirements and constraints of the operational task to be performed by the plurality of aerial vehicles;
an aerial vehicle operational parameter of the plurality of aerial vehicles indicating operational capabilities of the plurality of aerial vehicle;
weather data comprising current weather data and forecasted weather data of an operational area to be covered by the plurality of aerial vehicles for completion of the operational task;
based on the operation data, determining an operational plan for a first coverage area corresponding to a first aerial vehicle from amongst the plurality of aerial vehicles for achieving an operational objective associated with the operational task;
comparing the first coverage area with a threshold coverage area; and
upon determining that the first coverage area does not cover the threshold coverage area, initiating determination of a second coverage area for a second aerial vehicle.

9. The method of claim 8, wherein the method further comprising:
determining a collective coverage area by combining the first coverage area and the second coverage area; and
continuing the determination of additional coverage areas corresponding to subsequent aerial vehicles from the plurality of aerial vehicles until the collective coverage area reaches the threshold coverage area.

10. The method of claim 9, wherein the method further comprising:
upon determining that the collective coverage area covers the threshold coverage area, determining a collective operational plan comprising a value of an operational output parameter for one or more selected aerial vehicles whose coverage areas contribute to the collective coverage area, wherein the operational plan specifies instructions for each selected aerial vehicle to achieve an operational objective; and
transmitting, selectively to each selected aerial vehicle whose coverage area contributes to the collective coverage area, a corresponding portion of the collective operational plan specific to that aerial vehicle.

11. The method of claim 8, wherein determining the operational plan comprises:
analyzing the data comprised within the operation data with respect to a predefined set of rules to determine the operational plan corresponding to one or more aerial vehicles selected from the plurality of aerial vehicles,
wherein the predefined set of rules indicates optimal flight paths, resource allocation, coverage patterns, and coordination strategies based on the operational task parameter, aerial vehicle operational parameter, and weather data, wherein the predefined set of rules comprises rules corresponding to determining efficient routes considering terrain and weather conditions, allocating resources based on vehicle capabilities and operational task requirements, selecting appropriate search patterns for the operational task at hand, establishing coordination protocols for multi-vehicle operations, adaptive planning algorithms to handle changing operational task parameters, risk assessment procedures, communication protocols, energy management strategies, and sensor utilization plans.

12. The method of claim 8, wherein:
the operational task is one of a survey, remote sensing operations, payload delivery, air ambulance service, environmental monitoring, emergency response activities, and surveillance and reconnaissance; and
the operational objective is one of locating and rescuing individuals on time, mapping a geographical area efficiently, monitoring a specified region with less resources, extinguishing a fire in timely manner, or combination thereof.

13. The method of claim 8, wherein the operational task parameter is one of the operational area, type of operational task, a desired search pattern, number of aerial vehicles, types of aerial vehicles, location of origin, desired operation time, altitude, or combination thereof.

14. The method of claim 8, wherein the operational output parameter is one of entry location, exit location, time of departure, time of arrival, attributes representing coverage area, number of aerial vehicles, search patterns corresponding to each aerial vehicle, flight paths corresponding to each aerial vehicle, speed corresponding to each aerial vehicle, altitude of operation of each aerial vehicle or combination thereof.

15. The method of claim 8, wherein the aerial vehicle operational parameter is one of an aerial vehicle speed, a fuel capacity, sensor capabilities, a communication range, or combination thereof.

16. A non-transitory computer-readable medium comprising instructions, the instructions being executable by a processing resource to:
obtain operation data comprising:
operational objective information corresponding to an operational task to be performed by a plurality of aerial vehicles, wherein the operational objective information comprises a value of a operational task parameter specifying requirements and constraints of the operational task to be performed by the plurality of aerial vehicles;
an aerial vehicle operational parameter corresponding to the plurality of aerial vehicles indicating operational capability of each of the plurality of aerial vehicles;
weather data comprising current weather data and forecasted weather data of an operational area to be covered by the plurality of aerial vehicles for completion of the operational task;
based on the operation data, determine a current operational plan comprising a current value of an operational output parameter for one or more aerial vehicles selected from the plurality of aerial vehicles, wherein the current operational plan specifies instructions for each selected aerial vehicle to achieve an operational objective;
receive a real-time value of an in-flight operational attribute corresponding to an aerial vehicle of the one or more selected aerial vehicles during execution of the operational task;
analyze the real-time value of the in-flight operational attribute with respect to an ideal value corresponding to the in-flight operational attribute; and
based on the analysis, upon determining that the real-time value of the in-flight operational attribute fails to achieve the ideal value corresponding to the in-flight operational attribute, determine an updated value corresponding to the operational output parameter for each of the one or more selected aerial vehicles for achieving the operational objective.

17. The non-transitory computer-readable medium of claim 16, wherein:
the operational task is one of a survey, remote sensing operations, payload delivery, surveillance and reconnaissance, environmental monitoring, and emergency response activities; and
the operational objective is one of locating and rescuing individuals, mapping a geographical area, monitoring a specified region, extinguishing a fire, or combination thereof.

18. The non-transitory computer-readable medium of claim 16, wherein the operational output parameter is one of entry location, exit location, time of departure, time of arrival, attributes representing coverage area, number of aerial vehicles, search patterns corresponding to each aerial vehicle, flight paths corresponding to each aerial vehicle, speed corresponding to each aerial vehicle, altitude of operation of each aerial vehicle or combination thereof.

19. The non-transitory computer-readable medium of claim 16, wherein the instructions being executable by the processing resource to:
determine the ideal value corresponding to the in-flight operational attribute based on time elapsed from start of the operational task.

20. The non-transitory computer-readable medium of claim 16, wherein the in-flight operational attribute is one of a current position, altitude, speed, heading, fuel level, battery charge level, sensor status, communication signal strength, detected obstacles, weather conditions encountered, operational task progress indicator, equipment status, payload status, or combination thereof.
